(19) United States
(12) Patent Application Publication
(10) Pub. No.: US 2016/0127434 A1
(43) Pub. Date: May 5, 2016

(54) SYSTEMS AND METHODS FOR TRANSMITTING AND RECEIVING BROADCAST DATA

(71) Applicants: Douglas Sup Yoon, Johns Creek, GA (US); Michael Stirling Cosson, Flowery Branch, GA (US)

(72) Inventors: Douglas Sup Yoon, Johns Creek, GA (US); Michael Stirling Cosson, Flowery Branch, GA (US)

(21) Appl. No.: 14/531,841

(22) Filed: Nov. 3, 2014

(51) Int. Cl. H04L 29/06

(52) U.S. Cl. CPC H04L 65/4076

(57) ABSTRACT

Systems and methods for transmitting and receiving broadcast data are disclosed. In one embodiment, a system includes a modulator configured to receive a stream of Ethernet packets and modulate the stream of Ethernet packets to produce a baseband signal, where each Ethernet data packet includes broadcast data that is encapsulated in a IP/UDP packet. The system can also include an upconverter configured to upconvert the baseband signal to a transmission frequency, and a transmitter configured to transmit the upconverted signal.

### BACKGROUND

Digital broadcasting is the practice of using digital data rather than analog waveforms to carry broadcasts over, for example, television channels or assigned radio frequency bands. Conventionally, digital broadcasts may encapsulate digital content inside MPEG transport streams such as MPEG2 transport streams. MPEG2 allows for multiple programs to be multiplexed over a single digital frequency. Existing infrastructures based on MPEG2 may not deliver internet data packets efficiently, however. Multiplexing can prove wasteful in a IP/UDP stack and can complicate data transmission. In current implementations, IP data carried in MPEG streams is not standardized or is proprietary.

Ethernet is a family of computer networking technologies for local area (LAN) and larger networks. The Ethernet standards comprise several wiring and signaling variants of the OSI physical layer, encompassing coaxial, twisted pair, and fiber optic physical media interfaces and speeds from 10 Mbit to 100 Gbit or more. Systems communicating over Ethernet use a stream of Ethernet packets in which each Ethernet packet transports an Ethernet frame as payload. Each Ethernet frame contains source and destination addresses and error-checking data so that damaged data can be detected.

An Ethernet packet is also commonly encapsulated inside another packet structure. For example, in IEEE 802.11b, an Ethernet packet is encapsulated inside a MAC header/footer, which is then encapsulated inside a PHY header and preamble. This additional encapsulation can be necessary to negotiate the complexities of multi-point, bi-directional traffic. Also, when transmitting over fiber, data may be encapsulated over asynchronous transfer mode (ATM), and if the fiber itself is carrying a visual signal, then there will also be packetizing on the physical layer, which adds more inefficiency. Such structures that require multiple encapsulations can be bulky and inefficient for transmission of data.

As a result there is a need for improved systems and methods to address the above mentioned deficiencies. It is with respect to these and other considerations that embodiments of the present disclosure are directed.

### SUMMARY

In one aspect, the present disclosure relates to a method that, in one embodiment, includes providing a stream of Ethernet packets, where each Ethernet packet includes broadcast data that is encapsulated in a IP/UDP packet. The method can also include modulating the stream of Ethernet packets to produce a baseband signal, upconverting the baseband signal to a transmission frequency, and transmitting the upconverted signal.

In another aspect, the present disclosure relates to a system that, in one embodiment, includes a modulator that is configured to receive a stream of Ethernet packets and modulate the stream of Ethernet packets to produce a baseband signal, where each Ethernet data packet includes broadcast data that is encapsulated in a IP/UDP packet. The system can also include an upconverter that is configured to upconvert the baseband signal to a transmission frequency, and a transmitter that is configured to transmit the upconverted signal.

In another aspect, the present disclosure relates to a system that, in one embodiment, includes an application server that is configured to provide a stream of Ethernet packets, where each Ethernet packet includes broadcast data that is encapsulated in a IP/UDP packet. The system can also include a modulator that is configured to receive the stream of Ethernet packets and modulate the stream of Ethernet packets to produce a baseband signal. The system can also include an upconverter that is configured to upconvert the baseband signal to a transmission frequency, and a transmitter that is configured to transmit the upconverted signal.

In another aspect, the present disclosure relates to a system that, in one embodiment, includes a receiver that is configured to receive a transmitted signal that has been upconverted from a baseband signal and the baseband signal has been produced from a modulated stream of Ethernet packets. Each of the Ethernet packets can include broadcast data that is encapsulated in a IP/UDP packet. The system can also include a demodulator that is configured to demodulate the received signal to produce an Ethernet packet stream that includes the broadcast data.

The foregoing and other objects, features, aspects, and advantages of the present disclosure will become more apparent from the following detailed description of the present disclosure when taken in conjunction with the accompanying drawings.

### BRIEF DESCRIPTION OF THE DRAWINGS

Reference will now be made to the accompanying drawings, which are not necessarily drawn to scale, and wherein:

FIG. 1A is a block diagram illustrating a system for transmitting broadcast data, according to an embodiment of the present disclosure;

FIG. 1B is a block diagram illustrating a system for receiving broadcast data, according to an embodiment of the present disclosure;

FIG. 2 is a flow diagram showing operations of a method for transmitting and receiving broadcast data, according to an embodiment of the present disclosure;

FIG. 3 is a diagram illustrating the structure of an Ethernet packet and frame; and

FIG. 4 is a computer architecture diagram for a computing system capable of implementing one or more embodiments of the present disclosure.

### DETAILED DESCRIPTION

The following detailed description is directed to systems and methods for transmitting and receiving broadcast data. Although exemplary embodiments of the present disclosure are explained in detail, it is to be understood that other embodiments are contemplated. Accordingly, it is not intended that the present disclosure is limited in its scope to the details of construction and arrangement of components set forth in the following description or illustrated in the drawings. The present disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Method steps may be performed in a different order than those described herein. Similarly, it is also to be understood that the mention of one or more components in a device or system does not preclude the presence of additional components or intervening components between those components expressly identified.

In the detailed description, references are made to the accompanying drawings that form a part hereof and that show, by way of illustration, specific embodiments or examples. In referring to the drawings, like numerals represent like elements throughout the several figures.

As briefly discussed above, information transmitted on an Ethernet network is sent in a data packet, a chunk of data enclosed in a wrapper for identification and to route the packet to the correct destination, where the destination can be the particular application or process running on a particular device. The wrapper includes headers and trailers, where headers are bits of data added to the beginning of a packet and trailers are added to the end of a packet. In accordance with some embodiments of the present disclosure, the packets can be created at the source device sending the information, for example an application server. The source device can pass the data to a protocol stack to break the data down into chunks and wrap each chunk, such that packets can be reassembled in the correct order at the destination. The protocol stack on the source device can then pass the packets to a network hardware interface device such as an Ethernet network interface card (MC), which can add the header and trailer to each packet to direct it to the correct destination.

At the receiving end, this process can be reversed. In some embodiments of the present disclosure, the packet can be read by the NIC at a receiving device, which can strip off the Ethernet preamble and start of frame delimiter and pass the frame up to the appropriate protocol stack. The protocol stack can read and strip off its headers and pass the remaining packet contents up to the application or process on the receiving device, or coupled to the receiving device, to which it was addressed.

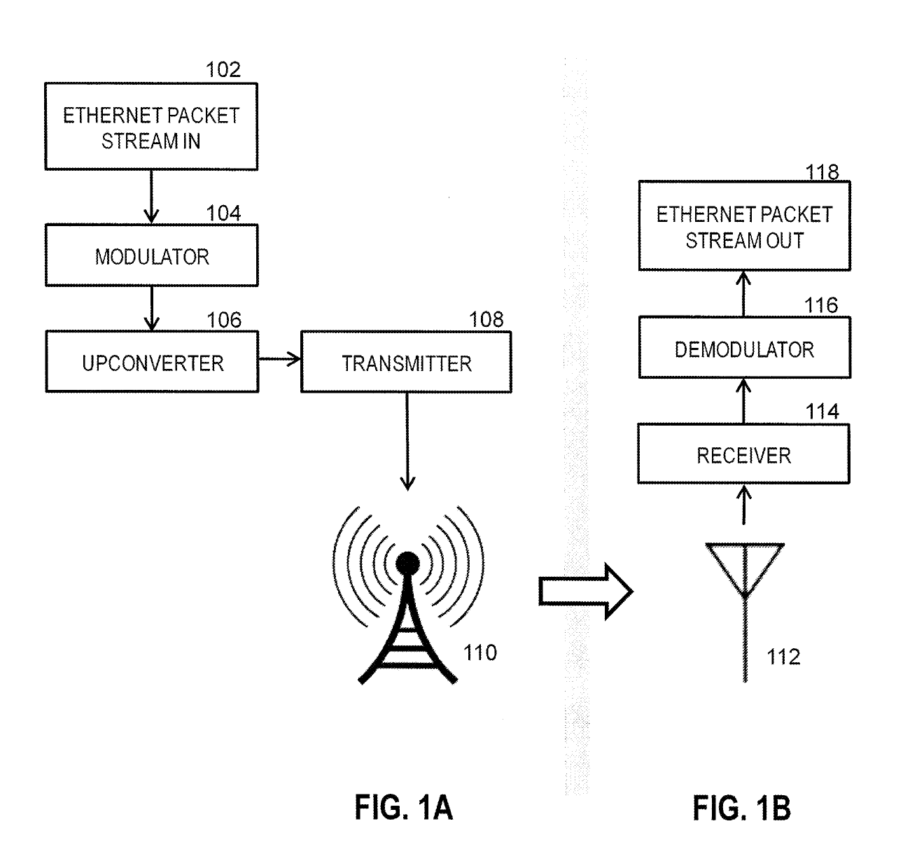

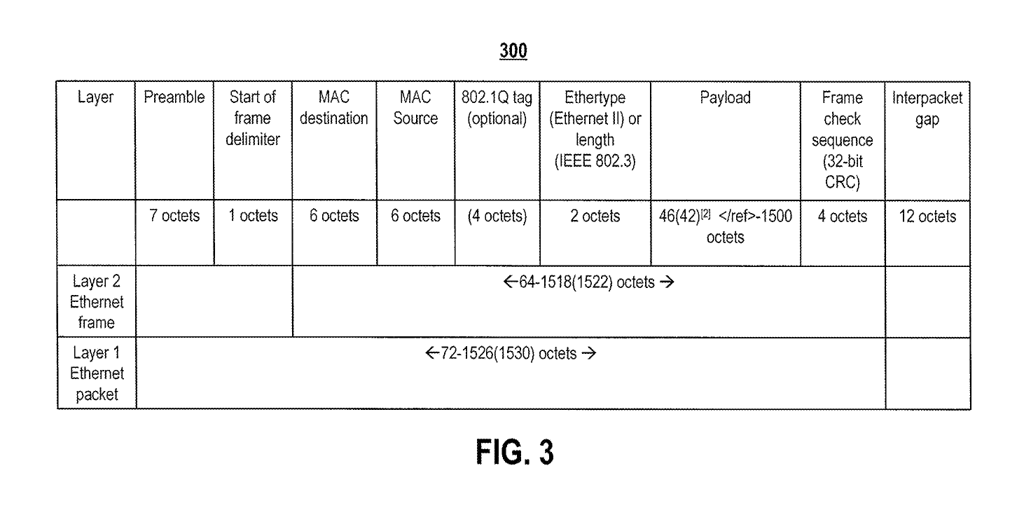

FIGS. 1A and 1B provide a block diagram of systems for transmitting broadcast data (FIG. 1A) and receiving broadcast data (FIG. 1B) according to some embodiments of the present disclosure. In FIG. 1A, a stream Ethernet packets 102 is received at a modulator 104. Each Ethernet packet includes broadcast data encapsulated in a IP/UDP packet. The broadcast data can include digital content such as, but not limited to, digital media content (e.g., audio, video, or images) or firmware data such as firmware updates. In some embodiments, each of the Ethernet packets is encapsulated once, without further encapsulations of the Ethernet packets themselves and without encapsulating the Ethernet packets along with packets of another protocol. Ethernet packets referred to herein can be structured in accordance with IEEE 802.3 protocol (see FIG. 3) or another type of Ethernet protocol now existing or to be developed.

Each of the Ethernet packets can consist of an Ethernet frame with the broadcast data in the payload. The broadcast data can be stored in the payload of a IP/UDP packet included in the payload of the Ethernet frame, consistent with IP/UDP-over-Ethernet format. For example, the payload of the Ethernet frame can include an IP data packet (e.g., IPv4 or IPv6) and the IP data packet payload can include a UDP packet with the broadcast data in the payload of the UDP packet.

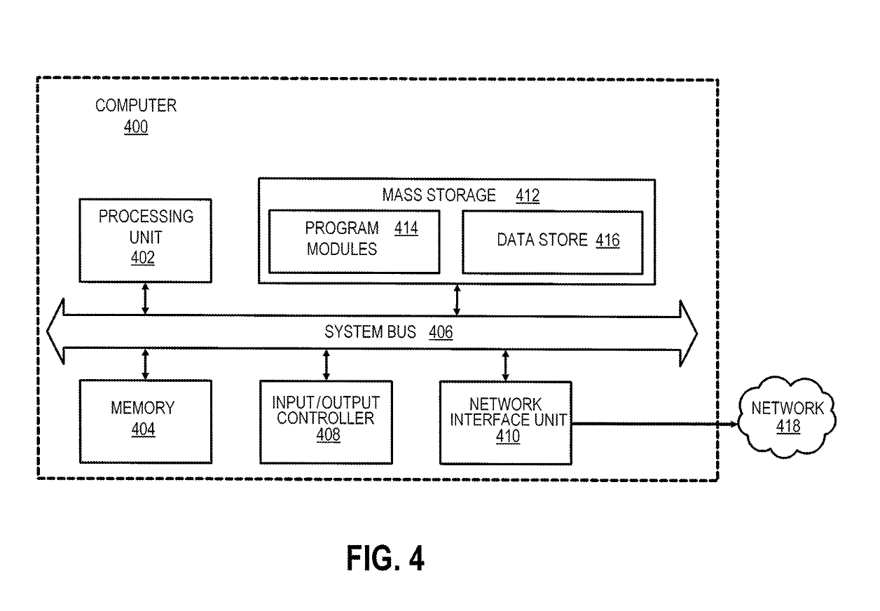

As will be described further below with reference to FIG. 3, according to the Ethernet packet and frame structure of IEEE 802.3, a trailing interpacket gap is required for bi-directional communication. In some embodiments of the present disclosure, however, unidirectional broadcasting can performed such that a response from a destination host is not required (i.e., there is no reverse transmission needed), and as such, a trailing interpacket gap is not needed. The Ethernet packets may be produced by a computing device configured, for example, as an application server that may include one or more components of the computing device 400 shown in FIG. 4. The stream of Ethernet packets may originate as output from an application running on the computing device. The computing device may use a network hardware interface device such as an Ethernet NIC (see, e.g., network interface unit 410 in FIG. 4) for producing the Ethernet packets to be sent to the modulator 104. In some embodiments, the stream of Ethernet packets may be provided using low-voltage differential signaling (LVDS), asynchronous serial interface (ASI), or using other techniques.

The modulator 104 receives the stream of Ethernet packets and modulates the stream of Ethernet packets to produce a baseband signal. An upconverter 106 receives the modulated stream of Ethernet packets and upconverts the stream of Ethernet packets to desired, higher frequency for transmission, for example: FCC specified Channel 7, whose center frequency is 177 MHz and is 6 MHz wide; Channel 21 at 515 MHz; or Channel 69 at 803 MHz, where each of them is specified by their center frequency (3 MHz above and 3 MHz below). A transmitter 108 receives and amplifies the upconverted signal, and a transmitter antenna 110 transmits the amplified signal. In some embodiments, the transmitter 108 and transmitter antenna 110 may be configured to transmit over, for example, UHF, VHF, or FM, among other protocols.

Data communicated between the modulator 104, upconverter 106, and transmitter 108 may be sent and received over one or more communication links such as Printed Circuit Board or heavily shielded cable. The modulation may be performed using one or more of vestigial sideband modulation (VSB) such as 8VSB, quadrature phase shift keying (QPSK), quadrature amplitude modulation (QAM) such as QAM256, and orthogonal frequency division multiplexing (OFDM), or others. Although shown in FIG. 1A as a wireless transmitter, in other embodiments the transmitter antenna 110 may be configured to transmit the broadcast data over cable, for example over coaxial cable, or over fiber such as optical fiber. For example, radio-over-fiber (RoF) architecture may be used. Also, although the modulator 104, upconverter 106, transmitter 108, and transmitter antenna 110 are shown in FIG. 1A as separate components, two or more of these components may be co-located and/or integrated into a single device, for example a desktop or laptop computer, server computer, or mobile computing device such as a smartphone or tablet computer.

Now referring to FIG. 1B a receiver antenna 112 is configured to receive the signal transmitted by the transmitter antenna 110 and to direct the received signal to a receiver 114. The receiver 114 can include detector and filter circuitry that detects the received signal and processes the signal to, for example, filter the received signal to obtain a desired portion of the signal such as a portion of the signal that has a desired frequency range. The received signal may be passed from the receiver 114 to a demodulator 116 that is configured to demodulate the signal and produce an output stream of Ethernet packets 118. The produced stream of Ethernet packets 118 can be a stream of reassembled Ethernet packets including the broadcast data transmitted by the transmission system shown in FIG. 1A. The receiver antenna 112, receiver 114, and/or demodulator 116 may be coupled to, or a component of, a computing device such as the computing device 400 shown in FIG. 4. The computing device may include a network adapter such as an NIC for producing the output Ethernet packet stream 118, for example the network interface unit 410 of the computer 400 shown in FIG. 4.

Although the receiver antenna 112, receiver 114, and demodulator 116 are shown in FIG. 1B as separate components, two or more of these components may be co-located and/or integrated into a single device, for example a desktop or laptop computer, server computer, or mobile computing device such as a smartphone or tablet computer. Further, although the receiver system of FIG. 1B can use a wireless antenna as shown, in other embodiments the transmitted signal can be received over a cable or optical fiber connection. The data communicated between the receiver antenna 112, receiver 114, and demodulator 116 may be sent and received over one or more communication links such as a twisted-pair connection, coaxial cable connection, optical fiber connection, or local wireless connection.

As an example implementation of aspects of the present disclosure, rather than using a bi-directional, destination-specific transmission for downloading data to a user's mobile device (e.g., a smartphone), data can be unidirectionally broadcasted (e.g., witlessly broadcasted over UHF, VHF, or FM) such that all equipped devices can selectively receive the broadcast data using, for example, a receiver antenna of the mobile device. For example, a store customer may have his mobile device configured to selectively receive data from a data carousel that is being broadcasted and that pertains to the particular location of the customer within the store.

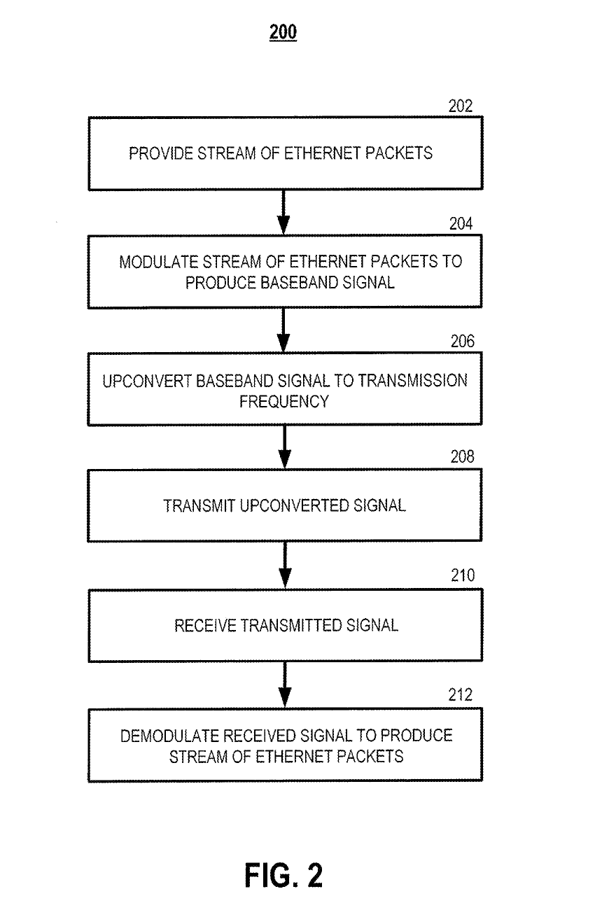

FIG. 2 is a flow diagram illustrating operations of a method 200 for transmitting and receiving broadcast data according to an embodiment of the present disclosure. At operation 202, a stream of Ethernet packets is provided. Each Ethernet packet can include broadcast data that is encapsulated in a IP/UDP packet. At operation 204, the stream of Ethernet packets is modulated to produce a baseband signal. At operation 206, the baseband signal is upconverted to a transmission frequency, and at operation 208, the upconverted signal is transmitted. At operation 210, the transmitted signal is received, and at operation 212, the received signal is demodulated to produce an Ethernet packet stream.

FIG. 3 is a diagram illustrating the structure of an Ethernet packet and frame 300 according to IEEE 802.3-2012. Data packets of the stream of Ethernet packets transmitted and received according to the embodiments of FIGS. 1A and 1B may be structured as shown in FIG. 3. Data on Ethernet is transmitted most-significant octet (byte) first, within each octet, the least-significant bit is transmitted first. The diagram of FIG. 3 shows a standard Ethernet frame, as transmitted, for a payload size up to 1500 octets. However, Gigantic Ethernet and other forms of high speed Ethernet may support larger frames.

An Ethernet frame according to IEEE 802.3-2012 starts following a 7-octet preamble and 1-octet start frame delimiter (SAD), which are part of the Ethernet packet enveloping the frame. The SAD is an 8-bit (1-byte) value marking the end of the preamble, which is the first field of an Ethernet packet, and indicating the beginning of the Ethernet frame. The SAD is immediately followed by the destination MAC address. The preamble of an Ethernet packet consists of a 56-bit (7-byte) pattern of alternating 1 and 0 bits, which allows devices on the network to detect a new incoming frame. The SAD is designed to break this pattern and identify the start of the actual frame. Physical layer transitive chips (PAYS) connect the Ethernet MAC to the physical medium, and the connection between a PHY and MAC is independent of the physical medium and may use a bus from the media independent interface family (MIDI). Fast Ethernet transitive chips can utilize the MIDI bus, which is a 4-bit (one nibble) wide bus, therefore the preamble is represented as 14 instances of 0x5, and the start frame delimiter is 0x5 0xD (as nibbles). Gigantic Ethernet transitive chips use a GMII bus, which is an 8-bit wide interface.

The header of the Ethernet frame has destination and source MAC addresses (each six octets in length), the EtherType field, and optionally a IEEE 802.1Q tag. The EtherType field is two octets long and can be used for different purposes. Values of 1500 and below mean that this field is used to indicate the size of the payload in octets, while values of 1536 and above indicate that it is used as an EtherType, to indicate which protocol is encapsulated in the payload of the frame. The IEEE 802.1Q tag, if present, is a four-octet field that indicates Virtual LAN (VLAN) membership and IEEE 802.1p priority.

With regard to the payload of the Ethernet frame, the minimum standard payload is 42 octets when an 802.1Q tag is present and 46 octets when absent. The maximum standard payload is 1500 octets. For the Ethernet packets that are transmitted and received in accordance with the embodiments of FIGS. 1A and 1B, the broadcast data can be held in the payload. The broadcast data can be stored in the payload of an IP/UDP packet included in the payload of the Ethernet frame, in accordance with IP/UDP-over-Ethernet format. For example, the payload of the Ethernet frame can include an IP data packet (e.g., IPv4 or IPv6) and the IP data packet payload can include a UDP packet with the broadcast data in the payload of the UDP packet.

The frame check sequence (FCS) is a 4-octet cyclic redundancy check which allows detection of corrupted data within the entire frame. The end of a frame is usually indicated by the end of data stream at the physical layer or by loss of the carrier signal. For example, in 10BASE-T, a receiving station detects the end of a transmitted frame by loss of the carrier. Some physical layers use an explicit end of data or end of stream symbol or sequence to avoid ambiguity. For example, Gigantic Ethernet uses an 8b/10b encoding scheme with particular symbols transmitted before and after a frame is transmitted.

The interpacket gap is idle time between packets. After a packet has been sent, transmitters are required to transmit a minimum of 96 bits (12 octets) of idle line state before transmitting the next packet. However, in some embodiments of the present disclosure, unidirectional broadcasting can performed such that a response from a destination host is not required (i.e., there is no reverse transmission needed), and as such, a trailing interpacket gap is optional (i.e., not required).

Some aspects of the present disclosure can be implemented with the use of a computer, and FIG. 4 provides a diagram for a general computer 400 capable of implementing various aspects of one or more embodiments of the present disclosure. For example, the computer 400 may be configured to perform operations shown in FIG. 2, and the functional components shown in FIGS. 1A and 1B may include some or all of the components of the computer 400. As shown, the computer 400 includes a processing unit 402, a system memory 404, and a system bus 406 that couples the memory 404 to the processing unit 402.

The computer 400 further includes a mass storage device 412 for storing program modules 414. The program module 414 may include modules executable to perform one or more functions associated with example embodiments illustrated in FIGS. 1A, 1B, and 2. The mass storage device 412 further includes a data store 416. The mass storage device 412 is connected to the processing unit 402 through a mass storage controller (not shown) connected to the bus 406. The mass storage device 412 and its associated computer storage media provide non-volatile storage for the computer 400. Although the description of computer-readable storage media contained herein refers to a mass storage device, such as a hard disk or CD-ROM drive, it should be appreciated by those skilled in the art that computer-readable storage media can be any available computer storage media that can be accessed and read by the computer 400.

By way of example, and not limitation, computer-readable storage media may include volatile and non-volatile, removable and non-removable media implemented in any method or technology for storage of information such as computer-storage instructions, data structures, program modules, or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 400. Computer-readable storage media as described herein does not include transitory signals.

According to various embodiments, the computer 400 may operate in a networked environment using logical connections to remote computers through a network 418. The computer 400 may connect to the network 418 through a network interface unit 410 connected to the bus 406. It should be appreciated that the network interface unit 410 may also be utilized to connect to other types of networks and remote computer systems. The computer 400 may also include an input/output controller 408 for receiving and processing input from a number of input devices. The bus 406 may enable the processing unit 402 to read code and/or data to/from the mass storage device 412 or other computer-storage media. The computer-storage media may represent apparatus in the form of storage elements that are implemented using any suitable technology, including but not limited to semiconductors, magnetic materials, optics, or the like.

The program module 414 may include software instructions that, when loaded into the processing unit 402 and executed, cause the computer 400 to perform one or more functions of the embodiments shown in FIG. 1 and FIG. 2. The program module 414 may also provide various tools or techniques by which the computer 400 may participate within the overall systems or operating environments using the components, flows, and data structures discussed throughout this description. In general, the program module 414 may, when loaded into the processing unit 402 and executed, transform the processing unit 402 and the overall computer 400 from a general-purpose computing system into a special-purpose computing system. The processing unit 402 may be constructed from any number of transistors or other discrete circuit elements, which may individually or collectively assume any number of states. More specifically, the processing unit 402 may operate as a finite-state machine, in response to executable instructions contained within the program module 414. These computer-executable instructions may transform the processing unit 402 by specifying how the processing unit 402 transitions between states, thereby transforming the transistors or other discrete hardware elements constituting the processing unit 402.

Encoding the program module 414 may also transform the physical structure of the computer-readable storage media. The specific transformation of physical structure may depend on various factors, in different implementations of this description. Examples of such factors may include, but are not limited to: the technology used to implement the computer-readable storage media, whether the computer-readable storage media are characterized as primary or secondary storage, and the like. For example, if the computer-readable storage media are implemented as semiconductor-based memory, the program module 414 may transform the physical state of the semiconductor memory, when the software is encoded therein. For example, the program modules 414 may transform the state of transistors, capacitors, or other discrete circuit elements constituting the semiconductor memory.

As another example, the computer-storage media may be implemented using magnetic or optical technology. In such implementations, the program modules 414 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present disclosure.

Numerous characteristics and advantages have been set forth in the foregoing description, together with details of structure and function. While various embodiments of the processing systems and methods have been disclosed in exemplary forms, many modifications, additions, and deletions can be made without departing from the spirit and scope of the present invention and its equivalents as set forth in the following claims.

Therefore, other modifications or embodiments as may be suggested by the teachings herein are particularly reserved as they fall within the breadth and scope of the claims here appended.

What is claimed is:

1. A method, comprising:
providing a stream of Ethernet packets, each Ethernet packet comprising broadcast data that is encapsulated in a IP/UDP packet;
modulating the stream of Ethernet packets to produce a baseband signal;
upconverting the baseband signal to a transmission frequency; and
transmitting the upconverted signal.

2. The method of claim 1, wherein each Ethernet packet of the stream of Ethernet packets is not encapsulated by a packet of a protocol other than Ethernet protocol.

3. The method of claim 1, wherein transmitting the upconverted signal comprises at least one of wireless transmission, coaxial cable transmission, and fiber transmission.

4. The method of claim 1, wherein the modulation comprises at least one of vestigial sideband modulation (VSB), quadrature phase shift keying (QPSK), quadrature amplitude modulation (QAM), and orthogonal frequency division multiplexing (OFDM).

5. The method of claim 1, wherein the stream of Ethernet packets is configured such as to not require a trailing interpacket gap.

6. The method of claim 1, wherein the broadcast data comprises at least one of media content and firmware data.

7. The method of claim 1, further comprising:
receiving the transmitted signal; and
demodulating the received signal to produce an Ethernet packet stream.

8. A system, comprising:
a modulator configured to receive a stream of Ethernet packets and modulate the stream of Ethernet packets to produce a baseband signal, each Ethernet data packet comprising broadcast data that is encapsulated in a IP/UDP packet;
an upconverter configured to upconvert the baseband signal to a transmission frequency; and
a transmitter configured to transmit the upconverted signal.

9. The system of claim 8, wherein each Ethernet packet of the stream of Ethernet packets is not encapsulated by a packet of a protocol other than Ethernet protocol.

10. The system of claim 8, wherein transmitting the upconverted signal comprises at least one of wireless transmission, coaxial cable transmission, and fiber transmission.

11. The system of claim 8, wherein the modulation comprises at least one of vestigial sideband modulation (VSB), quadrature phase shift keying (QPSK), quadrature amplitude modulation (QAM), and orthogonal frequency division multiplexing (OFDM).

12. The system of claim 8, wherein the stream of Ethernet packets is configured such as to not require a trailing interpacket gap.

13. The system of claim 8, wherein the broadcast data comprises at least one of media content and firmware data.

14. The system of claim 8, further comprising:
a receiver configured to receive the transmitted signal; and
a demodulator configured to demodulate the received signal to produce an Ethernet packet stream.

15. A system, comprising:
an application server configured to provide a stream of Ethernet packets, each Ethernet packet comprising broadcast data that is encapsulated in a IP/UDP packet;
a modulator configured to receive the stream of Ethernet packets and modulate the stream of Ethernet packets to produce a baseband signal;
an upconverter configured to upconvert the baseband signal to a transmission frequency; and
a transmitter configured to transmit the upconverted signal.

16. The system of claim 15, further comprising:
a receiver configured to receive the transmitted signal; and
a demodulator configured to demodulate the received signal to produce an Ethernet packet stream.

17. The system of claim 15, wherein each Ethernet packet of the stream of Ethernet packets is not encapsulated by a packet of a protocol other than Ethernet protocol.

18. The system of claim 15, wherein transmitting the upconverted signal comprises at least one of wireless transmission, coaxial cable transmission, and fiber transmission.

19. The system of claim 15, wherein the modulation comprises at least one of vestigial sideband modulation (VSB), quadrature phase shift keying (QPSK), quadrature amplitude modulation (QAM), and orthogonal frequency division multiplexing (OFDM).

20. The system of claim 8, wherein the stream of Ethernet packets is configured such as to not require a trailing interpacket gap.
